(19) United States
(12) Patent Application Publication
(10) Pub. No.: US 2021/0403606 A1
(43) Pub. Date: Dec. 30, 2021

(54) METHOD FOR SEPARATING AND PURIFYING POLYSACCHARIDES FROM GANODERMA SPORES

(71) Applicants: ZHONGKE HEALTH INDUSTRY GROUP JIANGSU PHARMACEUTICAL CO., LTD., ITaizhou (CN); NANJING ZHONGKE PHARMACEUTICAL CO., LTD., Nianjing (CN)

(72) Inventors: Yuan GUO, Taizhou (CN); Yifan QIAN, Taizhou (CN); Weiwei SHI, Taizhou (CN); Kewei HUA, Taizhou (CN); Yunyun ZHU, Taizhou (CN); Suling CHEN, Nanjing (CN)

(21) Appl. No.: 17/278,671

(22) PCT Filed: Dec. 11, 2018
(86) PCT No.: PCT/CN2018/120283

§ 371 Date: Mar. 23, 2021

(30) Foreign Application Priority Data
Nov. 6, 2018 (CN) 201811313710.4

(51) Int. Cl. C08B 37/00

(52) U.S. Cl. CPC C08B 37/0003

(57) ABSTRACT

The present invention discloses a method for separating and purifying polysaccharides from Ganoderma spores. The method includes ultrasonically extracting defatted Ganoderma spore powder and filtering with a plate and frame filter press to obtain a filtrate, and then precipitating the filtrate by passing sequentially through ethanol with a mass concentration of 75% and ethanol with a mass concentration of 85%, and filtering, to obtain polysaccharides which have a significant inhibitory effect on transplanted tumors in animals.

### TECHNICAL FIELD

The present invention relates to the field of Chinese medicine pharmacy, and specifically, to a method for separating and purifying polysaccharides from Ganoderma spores.

### RELATED ART

Ganoderma is one of traditional and precious Chinese medicinal materials, and is known as the “fairy herb”. It has an extremely high reputation in Chinese traditional culture. Ganoderma lucidum and Ganoderma sinense in the Ganoderma have been included in the Pharmacopoeia of the People's Republic of China, clearly stating that they have major functions of “tonifying qi and soothing nerves, relieving cough and asthma, and can be used for the indications such as restlessness, insomnia and palpitation, lung-qi deficiency, cough and asthma, consumptive disease, shortness of breath, and loss of appetite”.

Ganoderma spores are the reproductive cells ejected from Ganoderma pilei during the growth and maturity period of Ganoderma, that is, seeds of Ganoderma. Ganoderma spores have a plurality of effects, such as enhancing the body's immunity, inhibiting tumors, preventing liver from damage, and resisting radiation. They have been widely used in medicines and health foods.

At present, the commonly recognized active ingredients in Ganoderma spores are polysaccharides and triterpenes. Polysaccharides are one of the water-soluble active ingredients contained in fungi. Studies have found that they have a plurality of effects, such as enhancing the activity of human immune cells and inhibiting the formation of tumor cells. However, the content of the polysaccharides in natural fungi is generally low. Therefore, how to separate, purify, and enrich the polysaccharides from the natural fungi has been the research direction of relevant researchers in recent years.

### SUMMARY

An object of the present invention is to further concentrate and refine the polysaccharide active ingredients in Ganoderma spores, and enrich the polysaccharides having a molecular weight distribution with highest potency as the effective raw material ingredients in corresponding medicines and health foods.

The object of the present invention is achieved through the following technical solutions:

A method for separating and purifying polysaccharides from Ganoderma spores is provided, comprising ultrasonically extracting defatted Ganoderma spore powder and filtering with a plate and frame filter press to obtain a filtrate, and then precipitating the filtrate by passing sequentially through ethanol with a mass concentration of 75% and ethanol with a mass concentration of 85%, and filtering, to obtain a final precipitate. The final precipitate is further washed with a small amount of absolute ethanol, and then dried.

The defatted Ganoderma spore powder used above contains less than 1.0% of lipids and greater than 1.2% of polysaccharides.

The foregoing defatted Ganoderma spore powder is obtained by breaking the cell walls of fresh Ganoderma spores, extrusion granulating by adding an appropriate amount of water, drying, and then defatting through CO₂ supercritical extraction. The CO₂ supercritical extraction is preferably performed at an extraction temperature of 35-65° C., and an extraction pressure of 20-35 MPa for 2-7 h, with a CO₂ flow of 0.5-1 m³/h. The drying is preferably performed at a temperature of 50-70° C., and more preferably at 60° C.

The ultrasonic extraction is performed at 50-70° C. with an ultrasonic power of 15-26 kW for 1-3 h by adding water with an amount as 1.5-2.3 times as the weight of the defatted Ganoderma spore powder. Preferably, the ultrasonic extraction is performed at 60° C. with an ultrasonic power of 20 kW for 1 h by adding water with an amount as 2 times as the weight of the defatted Ganoderma spore powder.

The precipitating the filtrate by passing through ethanol with a mass concentration of 75% and filtering as described above specifically comprises adding ethanol with a mass concentration of 75% to the filtrate obtained by filtering with the plate and frame filter press in a volume as 2 times as that of the filtrate, standing overnight, and discarding a precipitate.

The precipitating the filtrate by passing through ethanol with a mass concentration of 85% and filtering as described above specifically comprises slowly adding 95% ethanol to the supernatant obtained by precipitating through ethanol with a mass concentration of 75% until the concentration of ethanol reaches 85%, standing, and filtering, to obtain a precipitate. The standing is preferably performed at 4° C. for 12 h.

The current polysaccharide products are mostly crude polysaccharide products prepared without optimization processes such as separation, refining, and screening, which is not conducive to the best effects of polysaccharides. The crude polysaccharides have a complex composition. In addition to the different components of polysaccharides, they further contain proteins, alkaloids, and other water-soluble components. Some polysaccharides are bound to pigments and proteins, which affects the conformational changes of the polysaccharides, and thus significantly affects the activity of the polysaccharides. Moreover, polysaccharides from different sources have different effects, and also have synergistic effects after compatibility. Therefore, the different extraction and purification processes of polysaccharides affect the composition of the polysaccharides, and thus have a certain degree of influence on the activity of the polysaccharides, so that it is very necessary to control the relative molecular mass of the polysaccharides.

According to the present invention, the anti-tumor activity of the polysaccharides from Ganoderma spores is related to the relative molecular mass, and the polysaccharides with relative molecular masses between 1000 to 500000 have a strong activity. It can be seen that different polysaccharides have their best relative molecular mass ranges for the biological activities.

### BRIEF DESCRIPTION OF THE DRAWINGS

FIG. 1 shows a fitted curve of standard molecular weights obtained by HPGPC.

### DETAILED DESCRIPTION

The present invention will be further explained below through specific examples.

### Example 1

a. The freshly harvested Ganoderma spores were broken, and then extrusion granulated by adding an appropriate amount of water, dried at 60° C. and defatted through CO₂ supercritical extraction. The supercritical extraction was carried out at an extraction temperature of 35° C., and an extraction pressure of 30 MPa for 3 h, with a CO₂ flow of 0.5 m³/h, to obtain defatted Ganoderma spore powder.

b. To the defatted Ganoderma spore powder was added water with an amount as 2 times as the weight of the defatted Ganoderma spore powder, and then ultrasonically extracted at 60° C. in an ultrasonic tank of 500 m³, with an ultrasonic power of 20 kW for 1 h. The resultant mixture was filtered with a plate and frame filter press to obtain a filtrate, and the filter residue was removed. To the filtrate was added 75% ethanol with a volume as 2 times as that of the filtrate, and stood overnight to obtain a supernatant, and the precipitate was discarded. Ethanol with a mass concentration of 95% was slowly added to the supernatant with stirring until the concentration of ethanol reached 85%. The mixture was allowed to stand at 4° C. for 12 h and then filtered to obtain a precipitate. The precipitate was washed with a small amount of absolute ethanol and then dried to obtain polysaccharides with a yield of 1.16%.

### Example 2

a. The freshly harvested Ganoderma spores were broken, and then extrusion granulated by adding an appropriate amount of water, dried at 50° C. and defatted through CO₂ supercritical extraction. The supercritical extraction was carried out at an extraction temperature of 45° C., and an extraction pressure of 20 MPa for 2 h, with a CO₂ flow of 1 m³/h.

b. To the defatted Ganoderma spore powder was added water with an amount as 2.3 times as the weight of the defatted Ganoderma spore powder, and then ultrasonically extracted at 50° C. in an ultrasonic tank of 500 m³, with an ultrasonic power of 26 kW for 1 h. The resultant mixture was filtered with a plate and frame filter press to obtain a filtrate, and the filter residue was removed. To the filtrate was added 75% ethanol with a volume as 2 times as that of the filtrate, and stood overnight to obtain a supernatant, and the precipitate was discarded. Then, ethanol with a mass concentration of 95% was slowly added to the supernatant with stirring until the concentration of ethanol reached 85%. The mixture was allowed to stand at 4° C. for 12 h and then filtered to obtain a precipitate. The precipitate was washed with a small amount of absolute ethanol and then dried to obtain polysaccharides with a yield of 1.20%.

### Comparative Example 1

a. The freshly harvested Ganoderma spores were broken, and then extrusion granulated by adding an appropriate amount of water, dried at 60° C. and defatted through CO₂ supercritical extraction. The supercritical extraction was carried out at an extraction temperature of 35° C., and an extraction pressure of 30 MPa for 3 h, with a CO₂ flow of 0.5 m³/h.

b. To the defatted Ganoderma spore powder was added water with an amount as 2 times as the weight of the defatted Ganoderma spore powder, and then ultrasonically extracted at low temperature in an ultrasonic tank of 500 m³, with an ultrasonic power of 20 kW for 1 h. The resultant mixture was filtered with a plate and frame filter press to obtain a filtrate, and the filter residue was removed. To the filtrate was added 85% ethanol with a volume as 2 times as that of the filtrate, and stood overnight to obtain a precipitate. The precipitate was washed with a small amount of absolute ethanol and then dried to obtain polysaccharides with a yield of 5.37%.

### Comparative Example 2. Extraction of Crude Polysaccharides

Distilled water was added to Ganoderma spore powder in an amount sufficient to form Ganoderma spores, and mixed evenly, to form particles. The particles were air-dried, and the lipids therein were removed by using a CO₂ supercritical extraction method. The supercritical extraction was carried out at an extraction temperature of 35° C., and an extraction pressure of 30 MPa for 3 h, with a CO₂ flow of 0.5 m³/h. 10 kg of the defatted Ganoderma spores were weighed into an extraction tank, and 150 kg of water was added to soak for 2 h. The mixture was heated to boiling and kept refluxing for 4 h. The obtained extract was centrifuged to obtain a clear filtrate. The filtrate was concentrated to 5 kg, and 85% ethanol was added, stood for 24 h, to precipitate polysaccharides. The precipitate was filtered and dried to obtain polysaccharides with a yield of 11.48%.

### Test Example 1

The present invention will be further described below in terms of the efficacy in inhibiting transplanted tumors in animals:

1. Test materials

1.1. Test medicines: Ganoderma spore polysaccharides of the present invention (prepared according to the method in Example 1, referred to as No. 1), Ganoderma spore polysaccharides (prepared according to the method in Comparative Example 1, referred to as No. 2), and crude polysaccharides (prepared according to the method in Comparative Example 2, referred to as No. 3).

1.2. Animals: ICR mice, 18-22 g, half males and half females, provided by the Animal Laboratory of China Pharmaceutical University. The animals were fed with pellet feed in an air-conditioned room at a temperature of 18-24° C., and a relative humidity of 70%.

1.3. Positive medicine: Cyclophosphamide (CTX), provided by Jiangsu Shengdi Pharmaceutical Co., Ltd. Specification: 0.2 g/bottle.

2. Objects of test

2.1. Inhibitory effects of No. 1, No. 2, and No. 3 on the transplanted tumor Heps in mice by tail vein injection

2.2. Inhibitory effects of No. 1, No. 2, and No. 3 on the transplanted tumor S180 in mice by tail vein injection

3. Test method and steps

3.1. Inhibitory effects of No. 1, No. 2, and No. 3 on the transplanted tumor Heps in mice by tail vein injection

3.1.1. Route of administration: No. 1, No. 2, and No. 3 are administrated by tail vein injection (iv).

3.1.2. Schedule of administration: the mice are inoculated with solid-type Heps tumors according to protocols of transplanted tumor research, and 24 hours after inoculation, the medicines are intravenously administered once every other day for a total of 4 doses. On the day after stopping administration, the mice are sacrificed and dissected.

3.1.3. Dose setting: There are 6 groups in total, namely:

Blank control group (normal saline)

NO. 1: 3 mg/kg

NO. 1: 1 mg/kg

CTX: 30 mg/kg

Crude polysaccharide control group: 150 mg/kg

NO. 2: 3 mg/kg

3.1.4. Volume of administration: 0.4 ml/20 g

3.1.5. Test method: 60 mice of the foregoing specification were inoculated with solid-type Heps tumors according to protocols of the transplanted tumor research. The mice were weighed 24 hours after inoculation, and randomly divided into 6 groups, each with 10 mice, having half males and half females. The blank control group and the CTX group were respectively used as a negative control group and a positive control group. 24 hours after inoculation, the medicines were intravenously administered once every other day for a total of 4 doses. The mice were weighed on the day after stopping administration. The tumor-bearing mice were sacrificed, and the tumor masses were separated and weighed, and the obtained data was statistically processed (t-test).

3.1.6. Test result

As shown in Table 3, the results show that compared with the blank control group, the iv administration of No. 1 (3 mg/kg, 1 mg/kg) group can significantly inhibit the tumor growth of Heps (P<0.01, P<0.05), and reduce the weights of the test mice. However, compared with the positive medicine CTX group, the iv administration of No. 1 (3 mg/kg, 1 mg/kg) group has a lower effect and the effect is significantly better than No. 2 (3 mg/kg) group and the crude polysaccharide control group (150 mg/kg).

TABLE 3
Inhibitory effects of No. 1, No. 2, and No. 3 on the transplanted
tumor Heps in mice (X ± SD) (n = 10)

| | | | | | Tumor |
|---|---|---|---|---|---|
| | | Weight | | Tumor | inhibition |
| | Dose | Before | After | weight | rate |
| Group | (mg/kg) | administration | administration | (g) | (%) |
| Control group | | 20.3 ± 1.31 | 27.3 ± 2.65 | 1.64 ± 0.33 | |
| NO. 1 | 3 | 20.0 ± 1.21 | 22.5 ± 2.08** | 0.56 ± 0.21** | 66.04 |
| | 1 | 20.1 ± 1.58 | 23.6 ± 1.96* | 0.88 ± 0.17* | 46.22 |
| Crude | 150 | 20.2 ± 2.17 | 24.3 ± 2.51* | 1.14 ± 0.26* | 30.20 |
| polysaccharide | 3 | 20.2 ± 1.34 | 23.8 ± 2.33** | 0.81 ± 0.26** | 50.38 |
| control group | | | | | |
| NO. 2 | | | | | |
| CTX | 30 | 20.0 ± 1.36 | 23.2 ± 2.74** | 0.42 ± 0.19** | 74.20 |

Note:
Compared with the blank control group,
*P < 0.05, and
**P < 0.01.

3.2. Inhibitory effects of No. 1, No. 2, and No. 3 on the transplanted tumor S180 in mice by tail vein injection

3.2.1. Route of administration: No. 1, No. 2, and No. 3 are administrated by tail vein injection (iv).

3.2.2. Schedule of administration: the mice are inoculated with solid-type 5180 tumors according to protocols of transplanted tumor research, and 24 hours after inoculation, the medicines are intravenously administered once every other day for a total of 4 doses. On the day after stopping administration, the mice are sacrificed and dissected.

3.2.3. Dose setting: There are 6 groups in total, namely:

Blank control group (normal saline)

NO. 1: 3 mg/kg

NO. 1: 1 mg/kg

Crude polysaccharide control group: 150 mg/kg

NO. 2: 3 mg/kg

CTX: 30 mg/kg

3.2.4. Volume of administration: 0.4 ml/20 g

3.2.5. Test method: 60 mice of the foregoing specification were inoculated with solid-type 5180 tumors according to protocols of the transplanted tumor research. The mice were weighed 24 hours after inoculation, and randomly divided into 6 groups, each with 10 mice, having half males and half females. The blank control group and the CTX group were respectively used as a negative control group and a positive control group. 24 hours after inoculation, the medicines were intravenously administered once every other day for a total of 4 doses. The mice were weighed on the day after stopping administration. The tumor-bearing mice were sacrificed, and the tumor masses were separated and weighed, and the obtained data was statistically processed (t-test).

3.2.6. As shown in Table 4, the results show that compared with the blank control group, the iv administration of No. 1 (3 mg/kg, 1 mg/kg) group can significantly inhibit the tumor growth of S180 (P<0.01, P<0.05), and reduce the weights of the test mice. However, compared with the positive medicine CTX group, the iv administration of No. 1 (3 mg/kg, 1 mg/kg) group has a lower effect and the effect is significantly better than No. 2 (3 mg/kg) group and the crude polysaccharide control group (150 mg/kg).

TABLE 4
Inhibitory effects of No. 1, No. 2, and No. 3 on the transplanted
tumor S180 in mice (X ± SD) (n = 10)

| | | | | | Tumor |
|---|---|---|---|---|---|
| | | Weight | | Tumor | inhibition |
| | Dose | Before | After | weight | rate |
| Group | (mg/kg) | administration | administration | (g) | (%) |
| Control group | | 20.5 ± 1.30 | 26.8 ± 2.38 | 1.60 ± 0.31 | |
| NO. 1 | 3 | 20.3 ± 1.05 | 23.4 ± 2.13** | 0.75 ± 0.24** | 53.27 |
| | 1 | 20.4 ± 1.43 | 24.6 ± 1.96* | 1.01 ± 0.32* | 36.70 |
| Crude | 150 | 20.3 ± 1.51 | 25.7 ± 1.53 | 1.21 ± 0.26* | 24.03 |
| polysaccharide | 3 | 20.2 ± 1.37 | 24.8 ± 2.13** | 0.95 ± 0.21** | 25.10 |
| control group | | | | | |
| NO. 2 | | | | | |
| CTX | 30 | 20.1 ± 1.28 | 23.2 ± 2.74** | 0.55 ± 0.18** | 65.71 |

Note:
Compared with the blank control group,
*P < 0.05, and
**P < 0.01.

In the present invention, the quality of the polysaccharide product prepared by the method in Example 1 was measured in terms of the following aspects:

I. Measurement of the Polysaccharide Content of the Product by Using a Sulfuric Acid-Anthrone Method

1. Preparation of a Sample Solution

2 g of the sample was precisely weighed into a 100 ml volumetric flask. 90 ml of hot water was added, and the sample was extracted in boiling water bath for 2 h. After cooling down to room temperature, the obtained extract was diluted with water to an indicated volume, and filtered. 2.0 ml of the filtrate was precisely measured, and 30 ml of ethanol was added. The resultant mixture was evenly shaken, and stood at 4° C. for 12 h. After that, it was centrifuged, and the supernatant was decanted out to obtain a precipitate. The precipitate was dissolved in water, evenly shaken, and made up to a volume of 100 ml with water, to obtain a sample solution.

2. Preparation of a Control Sample Solution

100 mg/L glucose solution was prepared. 0.2 ml, 0.4 ml, 0.6 ml, 0.8 ml, 1.0 ml, and 1.2 ml of control sample solutions were precisely measured respectively into a 10 ml volumetric flask, and water was added up to 2.0 ml. Then, 6 ml of a sulfuric acid-anthrone solution was precisely added, and evenly shaken. The obtained mixture was heated in boiling water bath for 15 min, and then the water bath was removed. The mixture was evenly shaken, and cooled in ice water for 15 min. The test was carried out according to an ultraviolet-visible spectrophotometry by using a corresponding reagent as a blank. The absorbance was measured at a wavelength of 625 nm, and a standard curve was drawn with the absorbance as an ordinate and the concentration as an abscissa.

3. Measurement of Polysaccharide Content

2.0 ml of a test solution was precisely measured into a 10 ml test tube with a stopper. Then, 6 ml of a sulfuric acid-anthrone solution was precisely added, and evenly shaken. The process was further carried out according to the method in the preparation of a control sample solution. The absorbance was measured as described above. The amount of glucose in the sample solution was read from the standard curve and calculated to obtain the polysaccharide content.

$$polysaccharide content ( \% ) = \frac{\begin{matrix}polysaccharide content in the sample \times \\ dilution factor\end{matrix}}{Mass of sample} \times 100$$

The polysaccharide content in the sample was calculated according to the standard curve, and the polysaccharide content in the example was calculated to be 92.0% by taking into account the mass of the sample.

II. Determination of Molecular Weight Distribution of the Product by High-Performance Gel Permeation Chromatography

1. Instruments and Reagents

HP1050 high performance liquid chromatograph

sEDEX 75 LT-ELsD evaporative light scattering detector

Standard molecular weight polysaccharide: Dextran standard 4,900,000 (MW4900000 Da),

Dextran standard 1,400,000 (MW1394000 Da),

Dextran standard 670,000 (MW668000 Da),

Dextran standard 410,000 (MW409800 Da),

Dextran standard 270,000 (MW273000 Da),

Dextran standard 150,000 (MW147600 Da),

Dextran standard 80,000 (MW80900 Da),

Dextran standard 50,000 (MW48600 Da),

Dextran standard 12,000 (MW11600 Da), and

Dextran standard 5,000 (MW5220 Da); all available from Fluka company

2. Chromatographic Conditions

Chromatography column: shodex Ohpak sB-805 HQ, shodex Ohpak sB-804 HQ, 300 mm×8 mm, provided by JAPAN SHOWA DENKO

Mobile phase: double-distilled water

Flow rate: 0.6 ml/min

ELsD detector drift tube temperature: 50° C.

ELsD detector pressure: 3.5 bar

ELsD detector gain value: 7

Chromatography workstation: Jiangshen Js-3050 type chromatography workstation (with GPC software)

3. Preparation of Refined Ganoderma Spore Polysaccharides

The sample was dissolved in an appropriate amount of water to a 5% sugar solution, and ammonia was added to adjust the pH to 7.8. The mixture was centrifuged and the precipitate was removed. The supernatant was decolorized with H₂O₂, and deproteinized by the sevag method. The deproteinized product was dialyzed, and precipitated by adding 85% alcohol. The precipitate was washed three times sequentially with absolute ethanol and acetone, and dried in vacuum, to obtain three batches of off-white refined Ganoderma spore polysaccharides.

4. Calibration of the Chromatographic Column

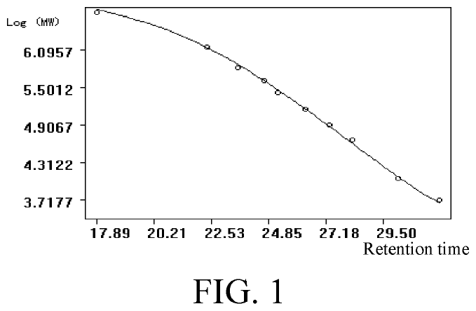

A series of standard molecular weight polysaccharides were prepared as 2 mg/ml of aqueous solutions, and then filtered with 0.45 μm microporous membrane filter, respectively. 20 μl of each of the filtrates was injected into the chromatograph. The peak retention time was recorded, and the chromatographic column was calibrated. The results were shown in Table 1. The curve of the retention time versus the logarithm of the molecular weight was fitted by using the GPC software in the chromatographic workstation, and the fitted curve was shown in FIG. 1.

TABLE 1
HPGPC standard curve

| | Molecular weight (Da) | | | | | | | | | |
|---|---|---|---|---|---|---|---|---|---|---|
| | 4900000 | 1394000 | 668000 | 409800 | 273000 | 147600 | 80900 | 48600 | 11600 | 5220 |
| Retention | 17.885 | 22.355 | 23.600 | 24.710 | 25.260 | 26.363 | 27.346 | 28.250 | 30.116 | 31.821 |
| time (min) | | | | | | | | | | |

5. Determination of the Molecular Weight and the Distribution Thereof

The Ganoderma spore polysaccharides in the examples were prepared as a 5 mg/ml solution in water, and high-speed centrifuged. The resultant supernatant was then filtered with 0.45 μm microporous membrane filter. 20 μl of each of the filtrate was injected into the chromatograph, and a chromatogram was recorded. The molecular weight and molecular weight distribution of the Ganoderma polysaccharides were calculated by using the GPC software in the chromatographic workstation, and the results were shown in Table 2.

TABLE 2
Results of the molecular weight and molecular weight distribution
of three batches of the Ganoderma spore polysaccharides

| | | | Weight average |
|---|---|---|---|
| Serial No. | | Normalized percentage (%) | molecular weight (Da) |
| 1 | Component 1 | 43.56 | 5.11 × 10⁵ |
| | Component 2 | 21.54 | 2.86 × 10⁵ |
| | Component 3 | 34.91 | 1.32 × 10³ |
| 2 | Component 1 | 53.44 | 4.85 × 10⁵ |
| | Component 2 | 21.83 | 2.68 × 10⁵ |
| | Component 3 | 24.72 | 1.12 × 10³ |
| 3 | Component 1 | 55.99 | 5.18 × 10⁵ |
| | Component 2 | 24.80 | 2.43 × 10⁵ |
| | Component 3 | 19.21 | 1.11 × 10³ |

What is claimed is:

1. A method for separating and purifying polysaccharides from Ganoderma spores, comprising ultrasonically extracting defatted Ganoderma spore powder and filtering with a plate and frame filter press to obtain a filtrate, and then precipitating the filtrate by passing sequentially through ethanol with a mass concentration of 75% and ethanol with a mass concentration of 85%, and filtering, to obtain a final precipitate.

2. The method for separating and purifying polysaccharides from Ganoderma spores according to claim 1, wherein the defatted Ganoderma spore powder is obtained by breaking the cell walls of fresh Ganoderma spores, extrusion granulating by adding an appropriate amount of water, drying, and then defatting through CO₂ supercritical extraction.

3. The method for separating and purifying polysaccharides from Ganoderma spores according to claim 2, wherein the drying is performed at a temperature of 50-70° C.

4. The method for separating and purifying polysaccharides from Ganoderma spores according to claim 2, wherein the CO₂ supercritical extraction used in the method is performed at an extraction temperature of 35-65° C., and an extraction pressure of 20-35 MPa for 2-7 h, with a CO₂ flow of 0.5-1 m³/h.

5. The method for separating and purifying polysaccharides from Ganoderma spores according to claim 1, wherein the ultrasonically extracting is performed at 50-70° C. with an ultrasonic power of 15-26 kW for 1-3 h by adding water with an amount as 1.5-2.3 times as the weight of the defatted Ganoderma spore powder.

7. The method for separating and purifying polysaccharides from Ganoderma spores according to claim 1, wherein the precipitating the filtrate by passing through ethanol with a mass concentration of 75% and filtering comprises adding 75% ethanol to the filtrate obtained by filtering with the plate and frame filter press in a volume as 2 times as that of the filtrate, standing overnight, and discarding a precipitate.

8. The method for separating and purifying polysaccharides from Ganoderma spores according to claim 1, wherein the precipitating the filtrate by passing through ethanol with a mass concentration of 85% and filtering comprises slowly adding 95% ethanol to the supernatant obtained by precipitating through ethanol with a mass concentration of 75% until the concentration of ethanol reaches 85%, standing, and filtering, to obtain a final precipitate.

9. The method for separating and purifying polysaccharides from Ganoderma spores according to claim 8, wherein the standing is performed at 4° C. for 12 h.

10. The method for separating and purifying polysaccharides from Ganoderma spores according to claim 1, wherein the final precipitate is washed with a small amount of absolute ethanol, and then dried.
